(19) United States
(12) Patent Application Publication
(10) Pub. No.: US 2024/0286146 A1
(43) Pub. Date: Aug. 29, 2024

(54) ELECTRONIC DUST COLLECTING DEVICE

(71) Applicant: Samsung Electronics Co., Ltd., Suwon-si, (KR)

(72) Inventors: Myungseob SONG, Suwon-si (KR); Myungsoo KANG, Suwon-si (KR); Hyongsoo NOH, Suwon-si (KR); Kyuho SHIN, Suwon-si (KR); Joonoh SHIN, Suwon-si (KR)

(21) Appl. No.: 18/655,935

(22) Filed: May 6, 2024

Related U.S. Application Data
(63) Continuation of application No. PCT/KR2022/018754, filed on Nov. 24, 2022.

(30) Foreign Application Priority Data
Dec. 27, 2021 (KR) 10-2021-0188381

(51) Int. Cl. B03C 3/08; B03C 3/38; B03C 3/47; B03C 3/82; F24F 8/192

(52) U.S. Cl. CPC B03C 3/08; B03C 3/38; B03C 3/47; B03C 3/82; F24F 8/192

(57) ABSTRACT

Disclosed herein is an electric dust collecting device including: a semi-conductive structure including at least one of a semi-conductive filter mesh or a semi-conductive grille, a plurality of low-voltage electrodes disposed on a downstream side of an air flow path than the semi-conductive structure, including a first dielectric layer and a first conductive electrode layer in the first dielectric layer, and configured to receive an applied low voltage, and a plurality of high-voltage electrodes arranged alternately with the plurality of low-voltage electrodes, including a second dielectric layer and a second conductive electrode layer in the second dielectric layer, and configured to receive an applied high-voltage, wherein the second conductive electrode layer includes a first discharge portion exposed to the outside of the second dielectric layer in an air flow direction and a second discharge portion adjacent to the first discharge portion, and a distance P between the first discharge portion and the second discharge portion is greater than a distance D between the first discharge portion or second discharge portion and the semi-conductive structure.

### CROSS-REFERENCE TO RELATED APPLICATIONS

This application is a continuation of International Application No. PCT/KR2022/018754 designating the United States, filed on Nov. 24, 2022, in the Korean Intellectual Property Receiving Office and claiming priority to Korean Patent Application No. 10-2021-0188381, filed on Dec. 27, 2021, in the Korean Intellectual Property Office, the disclosures of each of which are incorporated by reference herein in their entireties.

### BACKGROUND

### Field

The disclosure relates to an electric dust collecting device including a discharge portion and a dust collection portion.

### Description of Related Art

In general, high concentrations of aerosols in closed spaces, such as homes, rooms, shopping malls, factories, and offices may cause health problems for people. Such aerosols may be generated in confined spaces by smoking, cooking, cleaning, welding, grinding, and the like.

Electric dust collecting devices are devices that remove such aerosols and may be used in air purifiers or air conditioners with an air-purifying function.

An electric dust collecting device typically includes a charging portion that charges pollutants contained in the air to a positive pole (+) or a negative pole (−) by electrical discharge, and a collecting portion that include a high-voltage electrode and a low-voltage electrode to collect the pollutants charged by the charging portion.

Because the electric dust collecting device is provided with separate charging and collecting portions, the electric dust collecting device may have a large number of components and may require a process to assemble each component. In addition, the electric dust collecting device may have a large overall thickness because the charging and collecting portions are configured separately.

On the other hand, the electric dust collecting device charges pollutants contained in the air in the charging portion, and as discharge portions are arranged adjacent to each other, causing interference between the discharging portions. As a result, the charging performance may be low or sparks and discharge noise may occur.

### SUMMARY

Embodiments of the disclosure may provide an electric dust collecting device capable of preventing and/or reducing deterioration of charging performance in an electric dust collecting device including a discharge portion and a dust collecting portion.

Embodiments of the disclosure may provide an electric dust collecting device capable of improving charging performance in an electric dust collecting device that integrates a discharge portion and a dust collecting portion.

Embodiments of the disclosure may provide an electric dust collecting device in which a discharge portion and a dust collecting portion are formed integrally, which may prevent and/or reduce sparks and discharge noise from occurring.

According to an example embodiment of the disclosure, an electric dust collecting device includes: a semi-conductive structure including at least one of a semi-conductive filter mesh or a semi-conductive grille, a plurality of low-voltage electrodes disposed on a downstream side of an air flow path of the semi-conductive structure, including a first dielectric layer and a first conductive electrode layer in the first dielectric layer, and configured to receive an applied low voltage, and a plurality of high-voltage electrodes arranged alternately with the plurality of low-voltage electrodes, including a second dielectric layer and a second conductive electrode layer in the second dielectric layer, and configured to receive an applied high-voltage, wherein the second conductive electrode layer includes a first discharge portion exposed to the outside of the second dielectric layer in an air flow direction and a second discharge portion adjacent to the first discharge portion, wherein a distance P between the first discharge portion and the second discharge portion is greater than a distance D between the first discharge portion or second discharge portion and the semi-conductive structure.

The first discharge portion and the second discharge portion may protrude toward the semi-conductive structure.

The first discharge portion may include a first protrusion protruding toward the semi-conductive structure and the second discharge portion includes a second protrusion located adjacent to the first protrusion, and the distance D may be the shortest distance from the first protrusion or the second protrusion to the semi-conductive structure.

Each of the first protrusion and the second protrusion may include a sawtooth shape that protrudes sharply toward an upstream side of an air flow, each the first protrusion and the second protrusion may include a first inclined portion facing the semi-conductive structure from a base and a second inclined portion forming a ridge portion that meets the first inclined portion, wherein the distance P may be a distance between the ridge portion of the first protrusion and the ridge portion of the second protrusion, and the distance D is a distance between the ridge portion of the first protrusion or the ridge portion of the second protrusion and the semi-conductive structure.

The first protrusion and the second protrusion may be arranged continuously.

The first protrusion and the second protrusion may be spaced apart from each other.

The first discharge portion and the second discharge portion may extend in a direction intersecting the air flow direction on an upstream side of the second dielectric layer and be arranged to be spaced apart from each other.

The first discharge portion and the second discharge portion may be exposed to the outside through a plurality of openings formed on the upstream side of the second dielectric layer, and the distance D may be the shortest distance between two adjacent openings of the plurality of openings.

The second dielectric layer may include a plurality of openings having a V-shape formed on at least one of an upper and lower surfaces of the second dielectric layer, and an angled portion of each of the V-shaped openings is formed to face an upstream side based on the air flow direction.

The distance P may be a distance between the angled portions of two adjacent V-shaped openings of the plurality of openings, and the distance D may be a distance between the angled portion of each of the two adjacent V-shaped openings of the plurality of openings and the semi-conductive structure.

The second dielectric layer may include a plurality of openings having a W-shape formed on at least one of an upper and lower surfaces of the second dielectric layer, and an angled portion of each of the W-shaped openings is formed to face an upstream side based on the air flow direction.

The distance P may be a distance between the angled portions of two adjacent W-shaped openings of the plurality of openings, and the distance D may be a distance between the angled portion of the two adjacent W-shaped openings of the plurality of openings and the semi-conductive structure.

Each of the plurality of high-voltage electrodes may further include a dust collection portion located on a downstream side of the first discharge portion and the second discharge portion with respect to the air flow direction, and the first discharge portion and the second discharge portion may be formed integrally with the dust collection portion.

The semi-conductive structure may have a surface resistance of 10⁶ [ohm/sq] or more and 10¹¹ [ohm/sq] or less.

The distance D between the semi-conductive structure and the first discharge portion or the second discharge portion may be 4 mm or more, and the distance P between the first discharge portion and the second discharge portion may be 4 mm or more.

According to an example embodiment of the disclosure, an electric dust collecting device includes: a plurality of low-voltage electrodes including a first dielectric layer including an upper dielectric layer and a lower dielectric layer, and a first conductive electrode layer inside the first dielectric layer, a plurality of high-voltage electrodes arranged alternately with the plurality of low-voltage electrodes and including a second dielectric layer including an upper dielectric layer and a lower dielectric layer and a second conductive electrode layer inside the second dielectric layer, and a semi-conductive structure disposed on an upstream side of an air flow direction and including at least one of a semi-conductive filter mesh or a semiconducting grille, wherein the second conductive electrode layer includes a discharge portion that protrudes to face the semi-conductive structure and has one end exposed to the outside, and the discharge portion is provided in a plurality, wherein a distance P between a first discharge portion and a second discharge portion disposed adjacent to each other is greater than a distance D between the first discharge portion or the second discharge portion and the semi-conductive structure.

The first discharge portion may include a first protrusion protruding toward the semi-conductive structure and the second discharge portion includes a second protrusion located adjacent to the first protrusion, and the distance D may be the shortest distance from the first protrusion or the second protrusion to the semi-conductive structure.

Each of the first protrusion and the second protrusion may include a sawtooth shape that protrudes sharply toward an upstream side of an air flow, each the first protrusion and the second protrusion may include a first inclined portion facing the semi-conductive structure from a base and a second inclined portion forming a ridge portion that meets the first inclined portion, and the distance P may be a distance between the ridge portion of the first protrusion and the ridge portion of the second protrusion, and the distance D is a distance between the ridge portion of the first protrusion or the ridge portion of the second protrusion and the semi-conductive structure.

The first discharge portion and the second discharge portion may extend in a direction intersecting the air flow direction on an upstream side of the second dielectric layer and be arranged to be spaced apart from each other.

According to an example embodiment of the disclosure, an electric dust collecting device includes a semi-conductive structure including at least one of a semi-conductive filter mesh or a semi-conductive grille, and a plurality of carbon brushes disposed on a downstream side of the semi-conductive structure in an air flow path, and including a discharge portion disposed toward the semi-conductive structure to emit ions toward the semi-conductive structure, wherein a distance P between two adjacent discharge portions of the plurality of carbon brushes is greater than a distance D between the two discharge portions and the semi-conductive structure.

According to various example embodiments of the present disclosure, electrical interference between adjacent discharge portions of the electric dust collecting device can be minimized and/or reduced to provide a more stable and improved electric dust collecting device with improved charging performance.

According to an example aspect, in a structure in which the discharging portion and the collecting portion are integrated, aerosol collection efficiency can be improved while sparking and discharge noise can be prevented and/or reduced.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a perspective view of an electric dust collecting device according to various embodiments;

FIG. 2 is an exploded perspective view of the electric dust collecting device shown in FIG. 1 according to various embodiments;

FIG. 3 is an exploded perspective view of a filter assembly shown in FIG. 2, according to various embodiments;

FIG. 4 is a diagram illustrating an example configuration of a dust collection sheet and a location of the filter assembly according to various embodiments;

FIG. 5 is a perspective view of a low voltage electrode layer according to various embodiments;

FIG. 6 is a perspective view of an upstream side of a high-voltage electrode layer formed in a sawtooth shape, according to various embodiments;

FIG. 7 is a diagram illustrating a portion of the upstream side of a second conductive electrode layer shown in FIG. 6 and a semi-conductive filter mesh according to various embodiments;

FIG. 8 is a perspective view of an upstream side portion of the second conductive electrode layer having a sawtooth shape, according to various embodiments;

FIG. 9 is a diagram illustrating the upstream side portion of the second conductive electrode layer shown in FIG. 8 and a semi-conductive filter mesh according to various embodiments;

FIG. 10 is a perspective view of the upstream side portion of a second conductive electrode layer in a sawtooth shape, according to various embodiments;

FIG. 11 is a perspective view illustrating a differently shaped discharge portion extending in parallel with the semi-conductive filter mesh on an upstream side portion of the second conductive electrode layer according to various embodiments;

FIG. 12 is a diagram illustrating the upstream side portion of the second conductive electrode layer shown in FIG. 11 and the semi-conductive filter mesh according to various embodiments;

FIG. 13 is a perspective view of a plurality of V-shaped openings formed on an upper surface of a high-voltage electrode, according to various embodiments;

FIG. 14 is a perspective view of a plurality of V-shaped openings formed on a lower surface of the high voltage electrode, according to various embodiments

FIG. 15 is a diagram illustrating the upper surface of the high-voltage electrode having the V-shaped openings shown in FIG. 13, and the semi-conductive filter mesh according to various embodiments;

FIG. 16 is a perspective view of a plurality of W-shaped openings formed on an upper surface of a high-voltage electrode, according to various embodiments;

FIG. 17 is a perspective view of a plurality of W-shaped openings formed on a lower surface of the high-voltage electrode, according to various embodiments;

FIG. 18 is a diagram illustrating the upper surface of the high-voltage electrode having the W-shaped openings shown in FIG. 16, and the semi-conductive filter mesh according to various embodiments;

FIG. 19 is a perspective view of a conductive electrode pattern formed on the upstream side of the upper surface of the high-voltage electrode, according to various embodiments;

FIG. 20 is a perspective view of a conductive electrode pattern formed on an upstream side of a lower surface of the high-voltage electrode, according to various embodiments;

FIG. 21 is a diagram illustrating the conductive electrode pattern shown in FIG. 19 and the semi-conductive filter mesh according to various embodiments;

FIG. 22 is a diagram illustrating an example configuration in which the filter assembly is not resistive, as opposed to the filter assembly of FIG. 4 according to various embodiments;

FIG. 23 is a diagram illustrating the filter assembly disposed on an upstream and downstream side of an air flow, according to various embodiments;

FIG. 24 is a perspective view of the upstream and downstream sides of the second conductive electrode layer of the high-voltage electrode shown in FIG. 23 being toothed according to various embodiments;

FIG. 25 is a diagram illustrating an example of an electric dust collecting device comprising a carbon brush electrode according to various embodiments;

FIG. 26 is a diagram illustrating the carbon brush electrode shown in FIG. 2 and the semi-conductive filter mesh 5 according to various embodiments; and

FIG. 27 is a graph illustrating the performance of the electric dust collecting device as a function of the distance of the discharge portions and a distance between the discharge portions and the semi-conductive filter mesh according to various embodiments.

### DETAILED DESCRIPTION

Embodiments described in the disclosure and configurations shown in the drawings are merely examples of various example embodiments of the disclosure and may be used in various different ways at the time of filing of the present application to replace the embodiments and drawings of the disclosure.

In addition, the same reference numerals or signs shown in the drawings of the disclosure indicate elements or components performing substantially the same function.

The terms used herein are used to describe the various example embodiments and are not intended to limit and/or restrict the disclosure. The singular forms “a,”“an” and “the” are intended to include the plural forms as well, unless the context clearly indicates otherwise. In this disclosure, the terms “including”, “having”, and the like are used to specify features, figures, steps, operations, elements, components, or combinations thereof, but do not preclude the presence or addition of one or more of the features, figures, steps, operations, elements, components, or combinations thereof.

It will be understood that, although the terms “first”, “second”, “primary”, “secondary”, etc., may be used herein to describe various elements, but elements are not limited by these terms. These terms are only used to distinguish one element from another element. For example, without departing from the scope of the disclosure, a first element may be termed as a second element, and a second element may be termed as a first element. The term of “and/or” includes a plurality of combinations of relevant items or any one item among a plurality of relevant items.

As used herein, the terms “front”, “rear”, “upper”, “lower”, “left”, “right”, and the like are defined with reference to the drawings and are not intended to limit the shape and location of each component.

Hereinafter, various example embodiments of the disclosure will be described in greater detail with reference to the accompanying drawings.

An electric dust collecting device 1 (also referred to as an electrostatic precipitator) may refer, for example, to a device to remove aerosols generated by activities, such as smoking, cooking, cleaning, welding, grinding, and the like within a certain space. The electric dust collecting device 1 may be installed inside a device capable of performing an air filtering function, such as an air conditioner or air purifier.

An air purifier or air conditioner (not shown) may include an inlet (not shown) through which air from the outside is drawn in, the electric dust collecting device 1 filtering the air drawn in through the inlet, and a blowing fan (not shown) flowing the air. The air purifier or the air conditioner may also include an outlet (not shown) through which air filtered by a filter member is discharged. Air may flow through the inlet, the electric dust collecting device 1, and the outlet by operation of the blowing fan.

A device, such as an air purifier or air conditioner may include various filtering devices in addition to the electric dust collecting device 1. For example, a fine dust collection filter in the form of a non-woven fabric made of polypropylene resin or polyethylene resin and/or a granular activated carbon filter may be optionally provided.

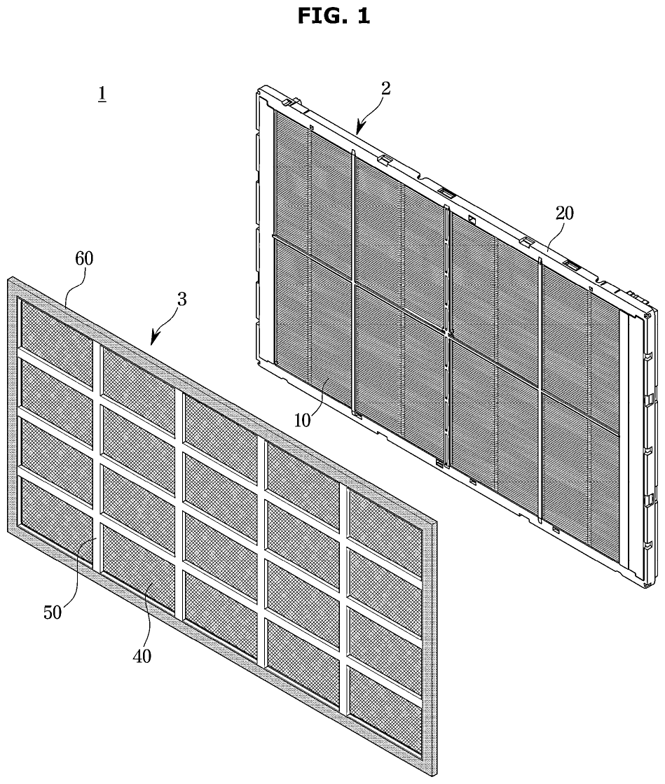

Referring to FIG. 1, the electric dust collecting device 1 may include a dust collection assembly 2 and a filter assembly 3. The dust collection assembly 2 and the filter assembly 3 may be spaced apart.

Air may pass through the filter assembly 3 and then through the dust collection assembly 2. In other words, the filter assembly 3 may be disposed on an upstream side of an air flow path than the dust collection assembly 2. For example, when the electric dust collecting device 1 is positioned perpendicular to the ground and air flows from front to back, the filter assembly 3 may be positioned on a front side of the dust collection assembly 2.

In another example, when the electric dust collecting device 1 is positioned horizontally with respect to the ground and air flows from bottom to top, the filter assembly 3 may be positioned on a lower side of the dust collection assembly 2. The arrangement of the filter assembly 3 and the dust collection assembly 2 is not limited to the above examples. Different arrangements may be used in which the air first passes through the filter assembly 3.

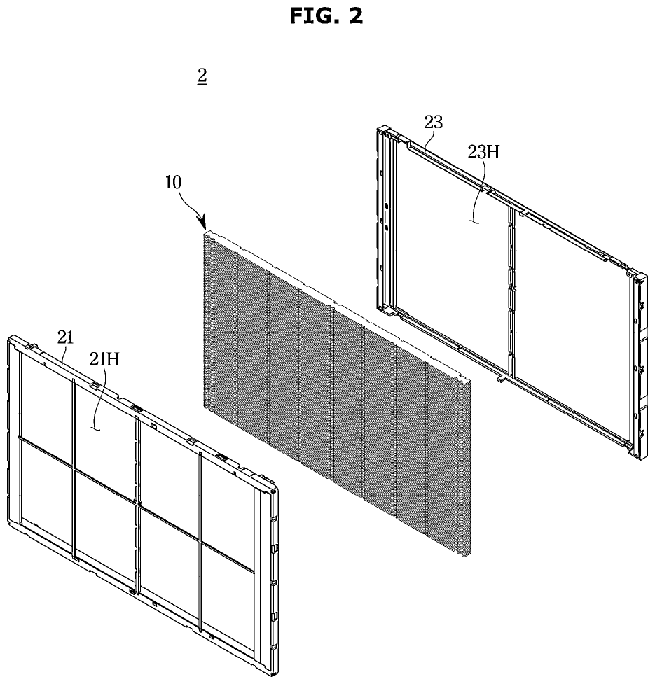

Referring to FIGS. 1 and 2, the dust collection assembly 2 may include a dust collection sheet 10 and a cover 20 covering the dust collection sheet 10. The cover 20 may be in the form of a frame surrounding the contour of the dust collection sheet 10. The cover 20 of the dust collection assembly 2 may include a first cover 21 and a second cover 23. The first cover 21 and the second cover 23 may be coupled. The dust collection sheet 10 may be disposed between the first cover 21 and the second cover 23 and may be protected by the first cover 21 and the second cover 23.

When the dust collection assembly 2 is disposed perpendicularly to the ground, the first cover 21 may be disposed on the front side of the dust collection sheet 10 and the second cover 23 may be disposed on the rear side of the dust collection sheet 10. Air may pass through the dust collection sheet 10 through openings 21H and 23H formed on an inner side of the first cover 21 and the second cover 23, respectively.

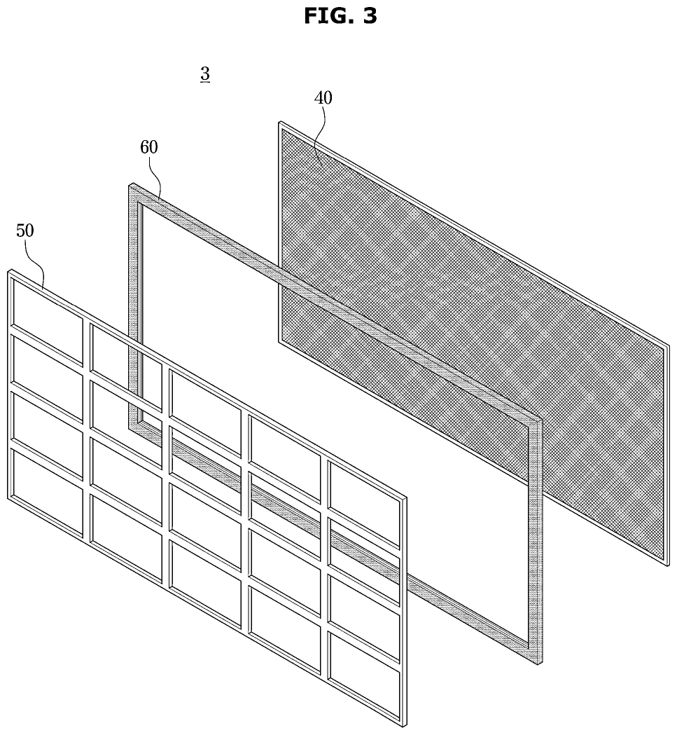

Referring to FIGS. 1 and 3, the filter assembly 3 may include semi-conductive structures 40 and 50 and a conductive member 60 arranged on the borders of the semi-conductive structures 40 and 50. The semi-conductive structures 40 and 50 may include at least one of the semi-conductive filter mesh 40 or a semi-conductive grill 50. The semi-conductive filter mesh 40 and the semi-conductive grille 50 may be formed integrally or may be provided detachably. The conductive member 60 may be referred to as a border electrode.

The filter assembly 3 may be arranged in a plate shape. The filter assembly 3 may have a shape (e.g., rectangular or circular) corresponding to the shape of the dust collection assembly 2. The semi-conductive structures 40 and 50 may have various shapes (e.g., rectangular or circular). The semi-conductive structures 40 and 50 may be arranged in a plate shape and may have a shape corresponding to the shape of the dust collection sheet 10. For example, the dust collection sheet 10 may have a square plate shape or a disc shape. The semi-conductive structures 40 and 50 may also have a square plate shape or a disc shape.

The semi-conductive structures 40 and 50 may be disposed at a location spaced apart from the dust collection sheet 10 by a given distance. In particular, the semi-conductive structures 40 and 50 may be spaced apart from the dust collection sheet 10 by a distance in the range of 4 mm or more to 10 mm or less.

FIG. 1 is a diagram illustrating an example embodiment in which the conductive member 60 is disposed on the borders of the semi-conductive structures 40 and 50 formed integrally with the semi-conductive filter mesh 40 and the semi-conductive grille 50, but the present disclosure is not limited thereto. The conductive member 60 may be provided on the borders of each of the semi-conductive filter mesh 40 and the semi-conductive grille 50.

The conductive member 60 may be provided on at least a portion of the borders of the semi-conductive structures 40 and 50. In FIGS. 1 and 3, the conductive member 60 is arranged to cover the entire border of the semi-conductive structures 40 and 50, but the conductive member 60 may be arranged on a portion of the borders of the semi-conductive structures 40 and 50.

When the filter assembly 3 is disposed perpendicularly to the ground, the semi-conductive grille 50 may be disposed on the front side or rear side of the semi-conductive filter mesh 40. The semi-conductive grille 50 may be formed integrally with or coupled to the semi-conductive filter mesh 40. The semi-conductive grille 50 may protrude from a surface of the semi-conductive filter mesh 40. The semi-conductive grille 50 may include a plurality of openings. The semi-conductive grille 50 may support the semi-conductive filter mesh 40 and protect the semi-conductive filter mesh 40.

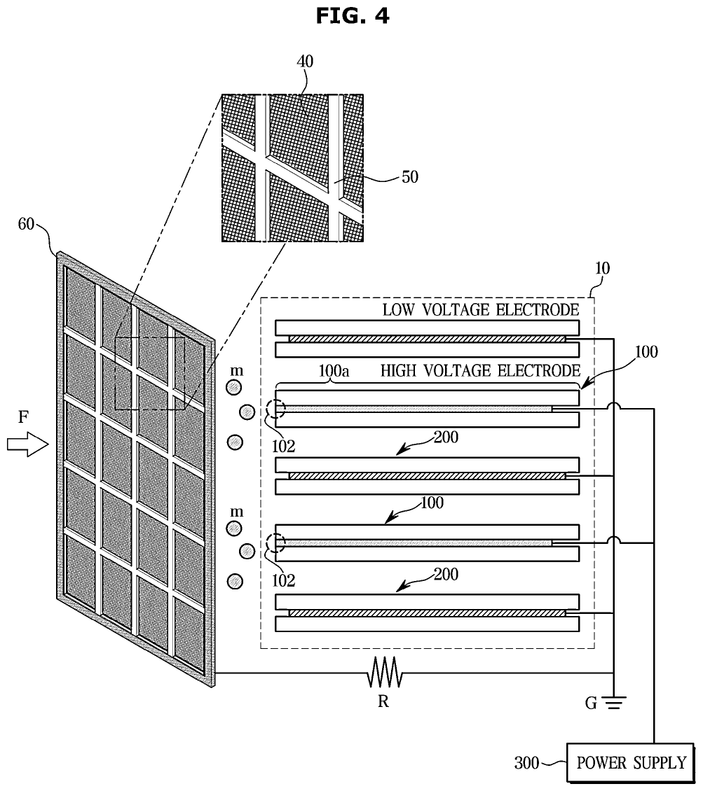

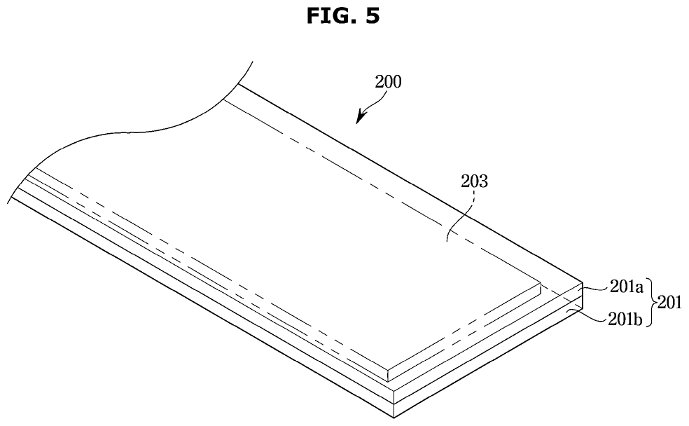

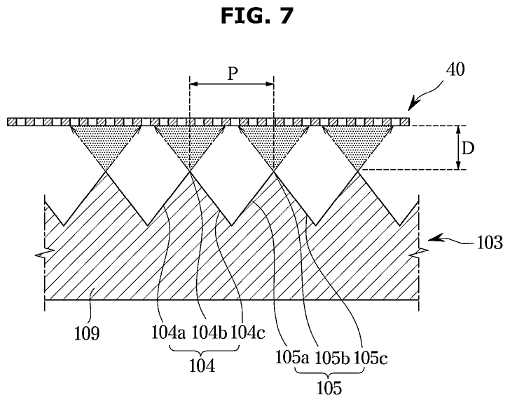

Referring to FIGS. 4, 5, 6 and 7 (which may be referred to as FIGS. 4 to 7), the conductive member 60 may be connected to the ground G. A resistance R may be arranged between the conductive member 60 and the ground G. The resistance R may prevent and/or reduce excessive current from flowing through the semi-conductive structures 40 and 50. Although the semi-conductive grille 50 is disposed close to the dust collection sheet 10, sparking and discharge noise may be prevented/reduced from occurring. The semi-conductive structures 40 and 50 may have surface resistance in the range of 10⁶ [ohm/sq] or more and 10¹¹ [ohm/sq] or less.

The dust collection sheet 10 may be formed by stacking a plurality of electrodes 100 and 200. The dust collection sheet 10 may include a high-voltage electrode 100, which is a positive electrode, and a low-voltage electrode 200, which is a negative electrode. The high-voltage electrode 100 and the low-voltage electrode 200 may each be provided in a plurality. The high-voltage electrodes 100 and the low-voltage electrodes 200 may be alternately disposed and stacked. The high-voltage electrodes 100 may be arranged to be appropriately spaced from the low-voltage electrodes 200 so that no sparks are generated between the high-voltage electrodes 100 and the low-voltage electrodes 200.

The dust collection sheet 10 may be electrically connected with a power supply 300. The power supply 300 may apply a high voltage to the high-voltage electrodes 100. The power supply 300 may include various circuits for applying a voltage to the high-voltage electrodes 100 and/or the low-voltage electrodes 200. The low-voltage electrodes 200 may be electrically connected to the ground G, and a low voltage may be applied to the low-voltage electrodes 200.

When a constant voltage is applied between the high-voltage electrode 100 and the respective low-voltage electrode 200, an electric field may be formed between the high-voltage electrode 100, which is the positive electrode, and the low-voltage electrode 200, which is the negative electrode. Here, the positive (or plus) electrode and the negative (or minus) electrode may be represented based on a potential difference between the two electrodes, with the positive electrode having a high level of potential and the negative electrode having a low level of potential.

The semi-conductive structures 40 and 50 may be positioned on an upstream side of the dust collection sheet 10 in a direction of air flow F. The respective high-voltage electrode 100 may have an opening 102 formed on an upstream side of the air flow direction F allowing the electrode to be exposed to the outside. The portion exposed to the outside by the opening 102 of the high-voltage electrode 100 may be defined as a discharge portion. In addition, a portion of the high-voltage electrode 100 that is positioned on a downstream side of the air flow from the discharge portion may be defined as a dust collection portion 100a.

The openings 102 may include openings 110, 120, 130, 140, 150, 150a, 160, and 160a, which will be described in greater detail below. Such a structure may allow for ions to be released from the externally exposed electrodes toward the semi-conductive structures 40 and 50, thereby discharging air.

The low-voltage electrode 200 may each include a first dielectric layer 201 and a first conductive electrode layer 203 disposed within the first dielectric layer 201. The first dielectric layer 201 may include a first upper dielectric layer 201a disposed above the first conductive electrode layer 203 and a first lower dielectric layer 201b disposed below the first conductive electrode layer 203. The first dielectric layer 201 may be formed by joining the first upper dielectric layer 201a and the first lower dielectric layer 201b. The first dielectric layer 201 may also be formed integrally without being divided into an upper and lower portions.

The high-voltage electrode 100 may include a second dielectric layer 101 and a second conductive electrode layer 103 disposed within the second dielectric layer 101. The second dielectric layer 101 may include a second upper dielectric layer 101a disposed above the second conductive electrode layer 103 and a second lower dielectric layer 101b disposed thereunder. Similarly, the second dielectric layer 101 may be formed by joining the second upper dielectric layer 101a and the second lower dielectric layer 101b.

The second dielectric layer 101 may be formed integrally without dividing the upper and lower portions. For example, the high-voltage electrode 100 may be manufactured by a double injection method in which the second dielectric layer 101 is injected by inserting a conductive material forming the second conductive electrode layer 103.

Air may pass through the semi-conductive structures 40 and 50 and the dust collection sheet 10 along the air flow direction F. The air may be charged before reaching the dust collection sheet 10. The air may be charged as it passes through the semi-conductive structures 40 and 50. The charged air may pass between the high-voltage electrode 100 and the low-voltage electrode 200.

The dust collection sheet 10 may release ions m to charge aerosols in the air to a positive pole (+) or negative pole (−). The second conductive electrode layer 103 exposed to the outside through the opening 110 of the high-voltage electrode 100 may release ions m into space. Air may come into contact with the released ions m and become charged. Aerosols in the air may be charged with the positive pole (+) or the negative pole (−). The portion exposed through the opening 102 of the high-voltage electrode 100 may be the discharge portion.

When the aerosols in the air are charged to the positive pole (+), the aerosols may be attached to the low-voltage electrode 200, which is the negative pole. When the aerosols are charged to the negative pole (−), the aerosols may be attached to the high-voltage electrode 100, which is the positive pole. As a result, the air that has passed through the electric dust collecting device 1 may be discharged in a clean state with the aerosols removed.

The second conductive electrode layer 103 of the high-voltage electrode 100 may not require a separate discharge portion by emitting ions m through the opening 102 formed to be exposed to the outside. According to such a structure, the second conductive electrode layer 103 may be printed to allow for the second conductive electrode layer 103 to be in close contact with a side where the opening 102 of the second dielectric layer 101 is formed so that the second conductive electrode layer 103 may be exposed to the outside through the opening 102 formed on the upstream side of the air flow direction.

Here, the discharge portion may be a portion exposed to the outside on an upstream side of the high-voltage electrode in the air flow direction. In addition, the charging portion may be a region formed on the upstream side of the air flow path than the discharging portion, and the dust collection portion may be a region formed a downstream side of the high-voltage electrode 100 and the low-voltage electrode 200 than the charging portion.

In the electric dust collecting device including the discharge portion and a dust collection portion, a distance between the semi-conductive structures 40 and 50 and the discharge portion is formed to be larger than a distance between the discharge portions. Accordingly, electrical interference between the discharge portions may occur, resulting in a deterioration of the charging (or electrostatic) performance.

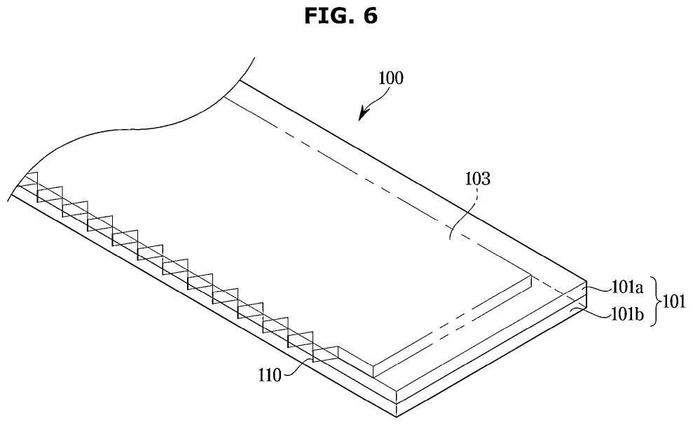

As shown in FIG. 6, the high-voltage electrode 100 may include a sawtooth shape that is partially exposed to the outside through the opening 110 formed on an upstream side of the second dielectric layer 101 in the air flow direction.

In the following, only the semi-conductive filter mesh 40 portion of the semi-conductive structures 40 and 50 is shown, and the relationship between the discharge portion and the semi-conductive structures 40 and 50 will be described in greater detail.

The second conductive electrode layer 103 may include a sawtooth shape protruding toward the upstream side of the air flow adjacent to the semi-conductive structures 40 and 50. The second conductive electrode layer 103 may include a base 109 and protrusions protruding from the base 109 toward the semi-conductive structures 40 and 50. The protrusions may be provided in a plurality and may be arranged continuously. The protrusions may be formed to protrude sharply toward the upstream side of the air flow.

The protrusions may include a first protrusion 104 and a second protrusion 105 disposed adjacent to the first protrusion 104. The first protrusion 104 and the second protrusion 105 are not limited to those shown in the drawings, but any two adjacent protrusions are sufficient.

The first protrusion 104 may include a first inclined portion 104a that faces the semi-conductive filter mesh 40 and is inclined to the right with respect to the base 109, and a second inclined portion 104c that faces the semi-conductive filter mesh 40 and in inclined to the left with respect to the base 109. The first inclined portion 104a and the second inclined portion 104c may be symmetrically inclined with respect to each other, and a portion where the first inclined portion 104a and the second inclined portion 104c meet may be a ridge portion 104b. The ridge portion 104b may be a portion of the first protrusion 104 having the shortest distance from the semi-conductive filter mesh 40.

The first inclined portion 104a and the second inclined portion 104c may be inclined surfaces, and the ridge portion 104b may be a point or a line.

Correspondingly, the second protrusion 105 may include a first inclined portion 105a and a second inclined portion 105c whose inclination may be symmetrical to the first inclined portion 105a, and further include a ridge portion 105b, which is a portion where the first inclined portion 105a and the second inclined portion 105c meet. The ridge portion 105b may be a portion of the second protrusion 105 having the shortest distance from the semi-conductive filter mesh 40.

A distance between the ridge portion 104b of the first protrusion 104 and the ridge portion 105b of the second protrusion 105 may be defined as a distance between the discharge portions P, and a distance between the ridge portion 104b of the first protrusion 104 or the ridge portion 105b or the ridge portion 105b of the second protrusion 105 and the semi-conductive filter mesh 40 may be defined as a distance D.

For example, the distance between the ridge portion 104b of the first protrusion 104 and the semi-conductive filter mesh 40 and the distance between the ridge portion 105b of the second protrusion 105 and the semi-conductive filter mesh 40 may be not the same, for example due to measurement reasons. In such cases where the distance between the ridge portions 104b and 105b is not constant, the distance D may be defined as the shortest distance between the ridge portions 104b and 105b and the semi-conductive filter mesh 40.

In other words, the distance P may be referred to as the distance between neighboring discharge portions, and the distance D may be referred to as the shortest distance between the discharge portion and the semi-conductive structures 40 and 50.

Here, the distance P between adjacent ridge portions 104b and 105b may be set to be greater than the distance D between the ridge portions 104b or 105b and the semi-conductive filter mesh 40. The discharge portion may be a portion of the second conductive electrode layer 103 that is exposed to the outside and capable of emitting ions. In the case where the discharge portion protrudes toward the upstream side of the air flow direction as shown in the drawings, the largest amount of ions may be emitted from the ridge portions 104b and 105b. According to such a structure, ions emitted from the adjacent ridge portions 104b and 105b to the semi-conductive filter mesh 40 may not electrically interfere with each other, thereby preventing and/or reducing the charging performance from being degraded.

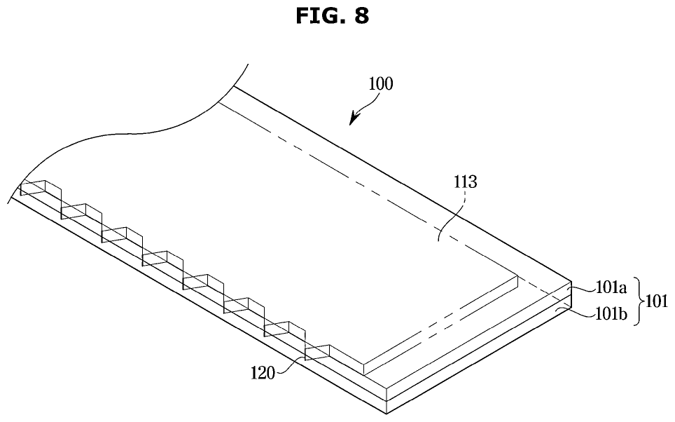

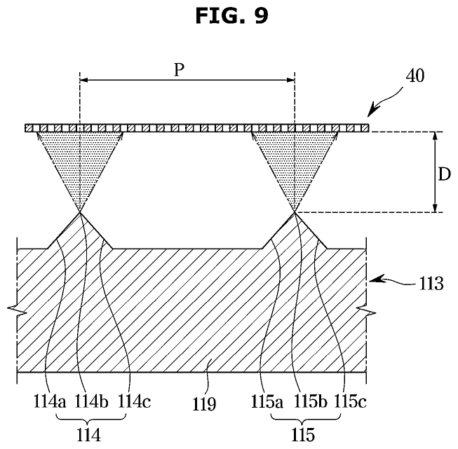

FIGS. 8 and 9 are perspective views illustrating a shape in which the pointed protrusions are arranged to be spaced apart from each other according to various embodiments. Referring to FIGS. 8 and 9, a second conductive electrode layer 113 may include a sawtooth shape protruding on the upstream side of the air flow direction. The second conductive electrode layer 113 may include a base 119 and protrusions protruding from the base 119 toward the semi-conductive filter mesh 40. The protrusions may be provided in a plurality, and may be arranged to be spaced apart from each other. The protrusions may be formed to protrude sharply toward the upstream side of the air flow.

The protrusions may include a first protrusion 114 and a second protrusion 115 disposed adjacent to the first protrusion 114. The first protrusion 114 and the second protrusion 115 are not limited to those shown in the drawings, and it is sufficient as long as they are two adjacent, spaced apart protrusions.

The first protrusion 114 may include a first inclined portion 114a and a second inclined portion 114c whose inclinations may be symmetrical, and a ridge portion 114b that is a portion where the first inclined portion 114a and the second inclined portion 114c meet. The ridge portion 114b may be a portion where a distance between the second conductive electrode layer 113 and the semi-conductive filter mesh 40 is shortest. The first inclined portion 114a and the second inclined portion 114c may be symmetrical to each other with respect to a line connecting the semi-conductive filter mesh 40 and the ridge portion 114b. Here, the ridge portion 114b may be the first ridge portion 114b.

The second protrusion 115 may include a first inclined portion 115a, a second ridge portion 115b, and a second inclined portion 115c formed to correspond to the first inclined portion 114a, the first ridge portion 114b, and the second inclined portion 114c, respectively, of the first protrusion 114. A distance between the first ridge portion 114b and the second ridge portion 115b may be referred to as the distance P, and a distance between the first ridge portion 114b or the second ridge portion 115b and the semi-conductive filter mesh 40 may be referred to as the distance D.

As described above, the distance P may be the distance between adjacent discharge portions, and the distance D may be the distance between the discharge portions and the semi-conductive structures 40 and 50. The distance D may be the shortest distance between the ridge portions 114b or 115b and the semi-conductive structures 40 and 50.

Here, the distance P between adjacent discharge portions may be set to be greater than the distance D between the ridge portions 114b or 115b and the semi-conductive filter mesh 40. Such a structure may improve the charging performance because ions emitted from the ridge portions 114b or 115b that are spaced apart from each other do not electrically interfere with each other.

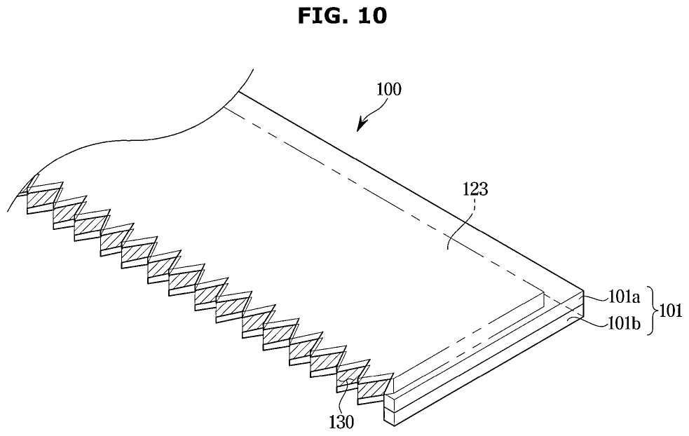

FIG. 10 is a perspective view illustrating an upstream side portion of a second conductive electrode layer 123 having a sawtooth shape, according to various embodiments. Referring to FIG. 10, the upstream side portion of the second conductive electrode layer 123 may have a continuously arranged sawtooth shape. In addition, the upstream side portions of the second upper dielectric layer 101a and the second lower dielectric layer 101b of the second dielectric layer 101 may also correspond to the shape of the second conductive electrode layer 123.

The upstream side portion of the second conductive electrode layer 123 may include the discharge portion exposed to the outside through the opening 130. The relationship between the distance P between the discharge portions and the distance D between the discharge portion and the semi-conductive structure according to an embodiment may also be applied to the geometry of FIG. 10.

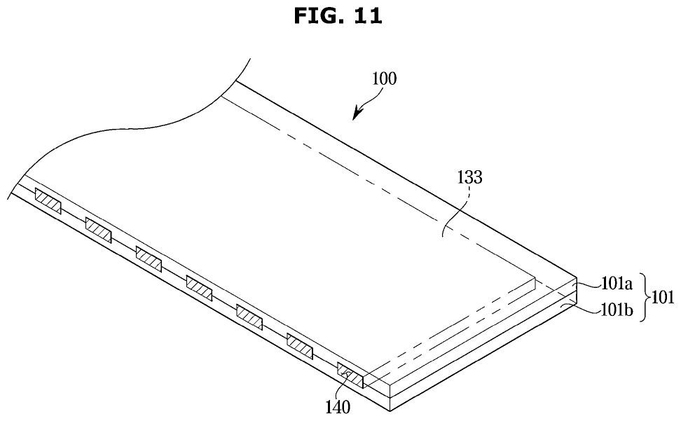

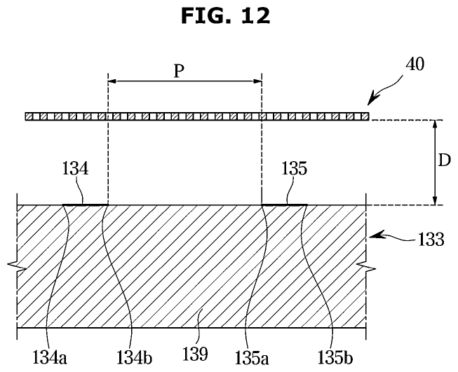

FIGS. 11 and 12 are include a perspective view and a diagram illustrating a plurality of openings having a straight shape formed on one side of the high-voltage electrode. Referring to FIGS. 11 and 12, a portion of a second conductive electrode layer 133 may be formed to be exposed to the outside on the upstream side of the air flow direction. The second conductive electrode layer 133 may be externally exposed through the opening 140.

The second conductive electrode layer 133 may include a base 139, and discharge portions 134 and 135 formed to be exposed toward the semi-conductive filter mesh 40. The discharge portions 134 and 135 may be exposed to the outside through the opening 140. The discharge portions 134 and 135 may include the first discharge portion 134 and the second discharge portion 135 adjacent to the first discharge portion 134. The first discharge portion 134 and the second discharge portion 135 may correspond to each other and may be spaced apart from each other.

The first discharge portion 134 may include a first end 134a and a second end 134b, and the second discharge portion 135 may include a first end 135a and a second end 135b. The second end 134b of the first discharge portion 134 and the first end 135a of the second discharge portion 135 may be disposed adjacent to each other.

Here, the distance P may be a distance between the first discharge portion 134 and the second discharge portion 135, and may be a distance between the second end 134b of the first discharge portion 134 and the first end 135a of the second discharge portion 135. The distance D may be a distance between the discharge portions 134 and 135 and the semi-conductive structure, and may be the shortest distance between the first discharge portion 134 or the second discharge portion 135 and the semi-conductive filter mesh 40.

The distance P between the two adjacent discharge portions 134 and 135 may be set to be greater than the distance D between the discharge portion 134 or 135 and the semi-conductive filter mesh 40. The advantages of such a structure are as described above.

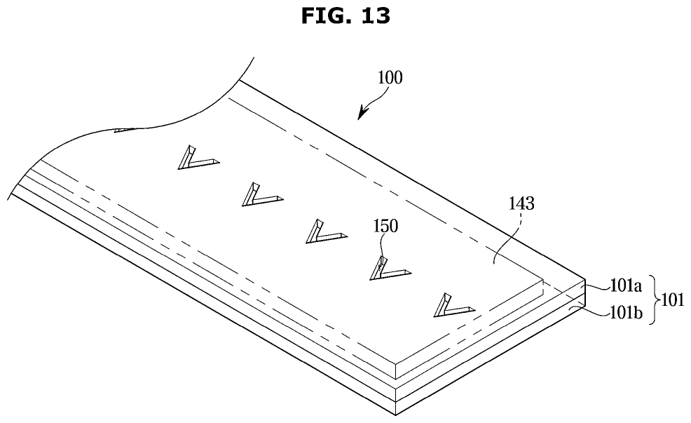

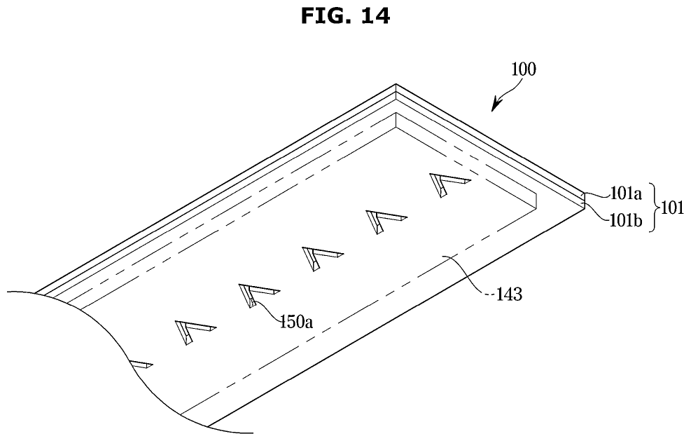

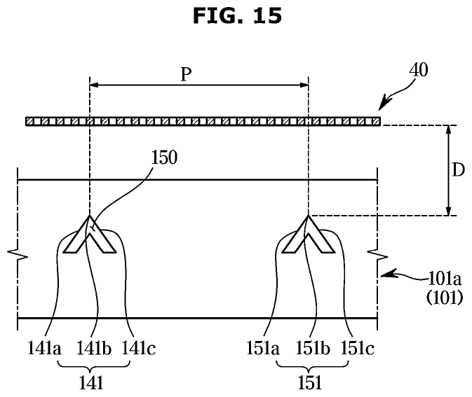

FIGS. 13 and 14 are perspective views illustrating a plurality of V-shaped openings formed on an upper or lower surface of a high-voltage electrode according to various embodiments. FIG. 15 is a diagram illustrating a top view of the high-voltage electrode according to FIG. 13 and the semi-conductive filter mesh according to various embodiments.

As shown in FIGS. 13 and 14, a plurality of openings 150 and 150a may be formed to have a V-shape on an upper or lower surface of the second dielectric layer 101. In other words, the opening 150 may be the V-shape formed on the upper surface of the second dielectric layer 101, and the opening 150a may be the V-shape formed on the lower surface of the second dielectric layer 101. In this case, an angled portion of the V-shape may be formed to face the upstream side based on the air flow direction F (see FIG. 4).

In an embodiment, while the shape and position of the openings 150 and 150a may be only slightly different, and it may be the same that a conductive electrode layer 143, which is partially exposed to the outside through the openings 150 and 150a, contacts the pollutants in the air and causes the pollutants to be charged with the positive pole (+) or the negative pole (−). In addition, the openings 150 and 150a may be formed simultaneously on the upper and lower surfaces of the second dielectric layer 101.

Referring to FIG. 15 the second conductive electrode layer 143 may include a first discharge portion 141 and a second discharge portion 151, which are V-shaped exposed by the two adjacent openings 150 among the V-shaped openings 150 formed on the upper surface of the second dielectric layer 101. The first discharge portion 141 and the second discharge portion 151 may have shapes corresponding to each other. Here, the first discharge portion 141 may be the first exposed surface 141, and the second discharge portion 151 may be the second exposed surface 151.

The first discharge portion 141 may include a thickness in a front-to-back direction of the air flow direction in a V-shape. The first discharge portion 141 may have a V-shape formed toward the semi-conductive filter mesh 40, and include the first inclined portion 141a and the second inclined portion 141c. The first inclined portion 141a and the second inclined portion 141c may be the two long sides of an isosceles triangle, and the first inclined portion 141a and the second inclined portion 141c may meet each other at the ridge portion 141b.

Similarly, the second discharge portion 151 may include the first inclined portion 151a, the second inclined portion 151c, and the ridge portion 151b to correspond to the first discharge portion 141. The first discharge portion 141 may emit ions from the V-shaped first exposed surface 141, and the second discharge portion 151 may emit ions from the V-shaped second exposed surface 151.

Here, the distance P between the adjacent discharge portions 141 and 151 may be a length between the ridge portion 141b of the first exposed surface 141 and the ridge portion 151b of the second exposed surface 151. In addition, the distance D between the discharge portion 141 or 151 and the semi-conductive filter mesh 40 may be the shortest length of the distance between the semi-conductive filter mesh 40 and the ridge portion 141b of the first discharge portion 141 or between the semi-conductive filter mesh 40 and the ridge portion 151b of the second discharge portion 151.

The distance P between the discharge portions 141 and 151 may be set to be greater than the distance D between the discharge portion 141 or 151 and the semi-conductive filter mesh 40. Such a structure may ensure that ions emitted from the discharge portions 141 and 151 (see FIG. 4) toward the semi-conductive structures 40 and 50 do not electrically interfere with each other.

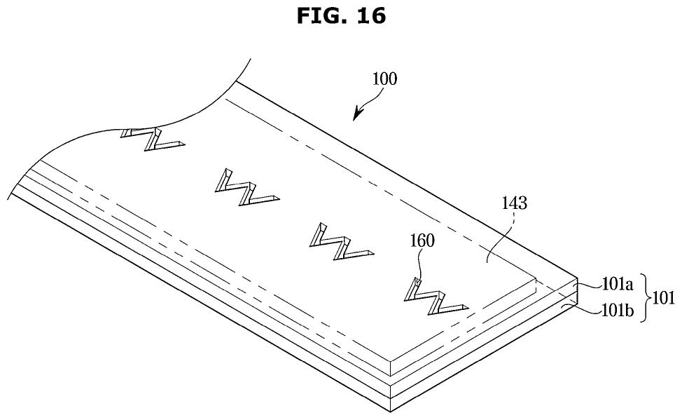

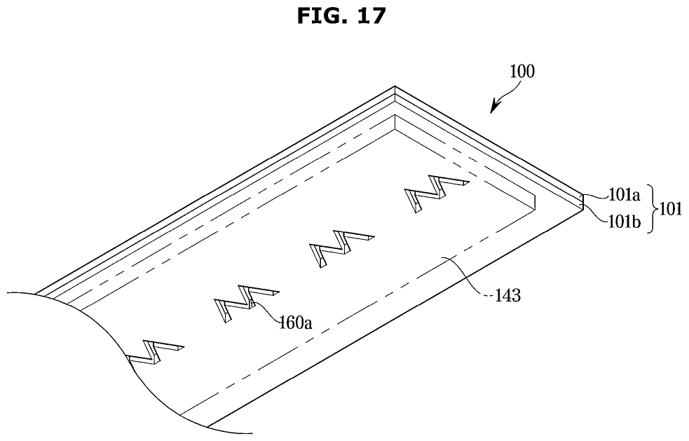

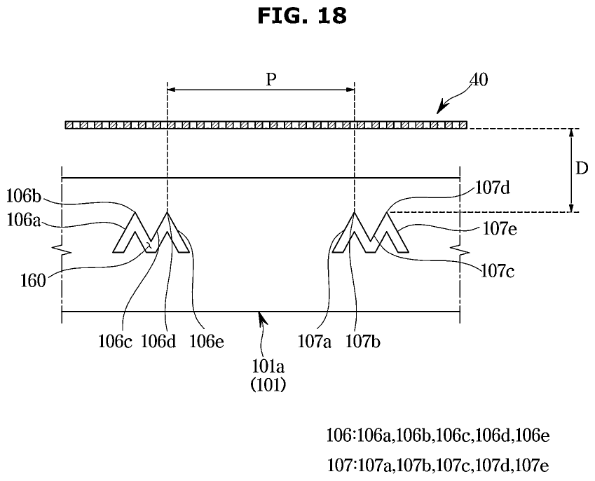

FIGS. 16 and 17 are perspective views illustrating a plurality of W-shaped openings formed on an upper or lower surface of a high-voltage electrode according to various embodiments. FIG. 18 is a diagram illustrating a top view of the high-voltage electrode according to FIG. 16 and the semi-conductive filter mesh according to various embodiments.

As shown in FIGS. 16 and 17, a plurality of openings 160 and 160a may be formed to have a W-shape on an upper or lower surface of the second dielectric layer 101. In other words, the opening 160 may be the W-shape formed on the upper surface of the second dielectric layer 101, and the opening 160a may be the W-shape formed on the lower surface of the second dielectric layer 101. In this case, an angled portion of the W-shape may be formed adjacent to the semi-conductive filter mesh 40. The openings 160 and 160a may be formed simultaneously on the upper and lower surfaces of the second dielectric layer 101.

Referring to FIG. 18, the second conductive electrode layer 143 may include a first discharge portion 106 and a second discharge portion 107, which are W-shaped exposed by the two adjacent openings 160 among the W-shaped openings 160 formed on the upper surface of the second dielectric layer 101. The first discharge portion 106 and the second discharge portion 107 may be spaced apart from each other. The first discharge portion 106 may be the first exposed surface 106, and the second discharge portion 107 may be the second exposed surface 107.

The first discharge portion 106 may extend to form a certain thickness in the front-to-back direction of the air flow direction in a W-shape. The first discharge portion 106 may include a first inclined portion 106a, a second inclined portion 106c, and a third inclined portion 106e. The second inclined portion 106c may be V-shaped, and the first inclined portion 106a and the third inclined portion 106e may be formed symmetrically with respect to the second inclined portion 106c. The first discharge portion 106 may include a first ridge portion 106b where the first inclined portion 106a and the second inclined portion 106c meet, and a second ridge portion 106d where the second inclined portion 106c and the third inclined portion 106e meet.

The second discharge portion 107 may include a first inclined portion 107a, a second inclined portion 107c having a V-shape, and a third inclined portion 107e. The second discharge portion 107 may include a first ridge portion 107b where the first inclined portion 107a and the second inclined portion 107c meet, and a second ridge portion 107d where the second inclined portion 107c and the third inclined portion 107e meet. The second ridge portion 106d of the first discharge portion 106 and the first ridge portion 107b of the second discharge portion 107 may be arranged adjacent to each other.

Here, the distance P between the adjacent discharge portions 106 and 107 may be a distance between the second ridge portion 106d of the first discharge portion 106 and the first ridge portion 107b of the second discharge portion 107. In addition, the distance D between the discharge portion 106 or 107 and the semi-conductive filter mesh 40 may be the shortest distance between the semi-conductive filter mesh 40 and the ridge portion 106b or 106d of the first discharge portion 106, or between the semi-conductive filter mesh 40 and the ridge portion 107b or 107d of the second discharge portion 107. Under such conditions, the distance P between the adjacent discharge portions 106 and 107 may be formed to be greater than the distance D between the semi-conductive filter mesh 40 and the discharge portion 106 or 107.

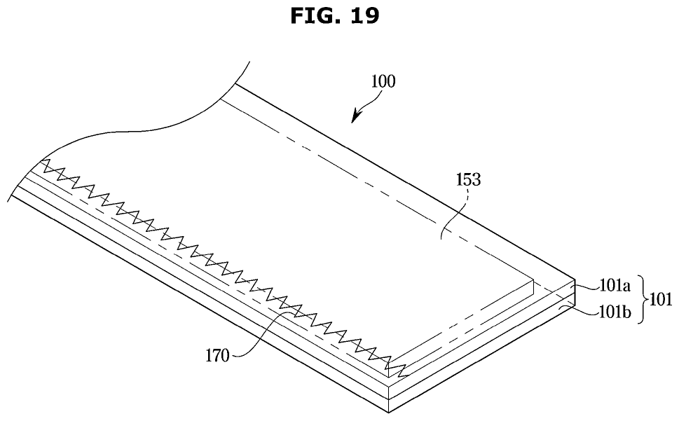

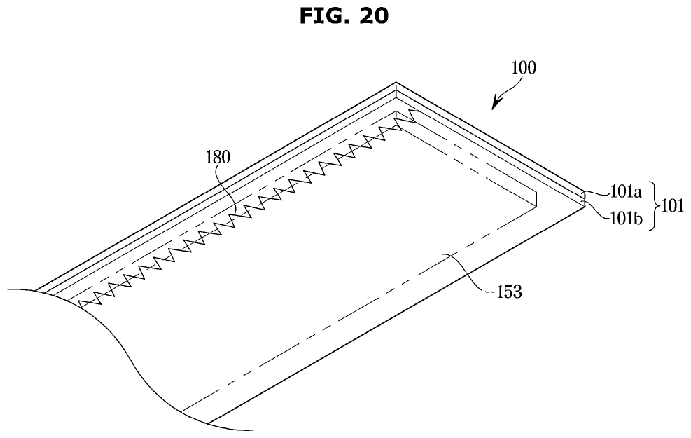

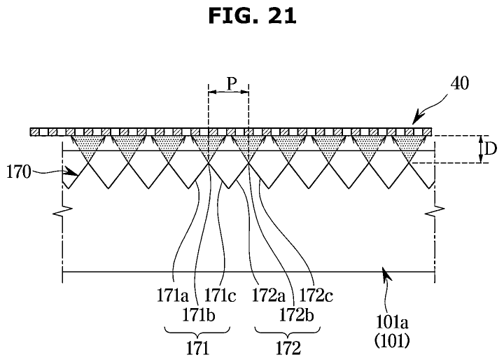

FIGS. 19 and 20 are perspective views illustrating a conductive electrode pattern formed on an upstream side of an upper or lower surface of a high-voltage electrode according to various embodiments. FIG. 21 is a diagram illustrating a top view of the high-voltage electrode according to FIG. 19 and the semi-conductive filter mesh according to various embodiments.

As shown in FIGS. 19 and 20, conductive electrode patterns 170 and 180 formed as a conductive electrode layer pattern directly on the second dielectric layer 101 may be formed without a second conductive electrode layer 153 inside the second dielectric layer 101 being not exposed to the outside. The conductive electrode patterns 170 and 180 may be formed on an upstream side of the upper surface or an upstream side of the lower surface of the second dielectric layer 101.

In other words, the conductive electrode patterns 170 and 180 may be formed directly on the upstream side of the upper surface of the upper dielectric layer 101a or directly on the upstream side of the lower surface of the lower dielectric layer 101b.

The conductive electrode patterns 170 and 180 may be produced by printing or applying a conductive material so as to form a pattern of conductive electrode layers on the second dielectric layer 101. The conductive electrode patterns 170 and 180 formed directly on the second dielectric layer 101 may contact pollutants in the air to cause the pollutants to be charged with the positive pole (+) or the negative pole (−). In this case, the pattern may be formed to have a variety of shapes, but may be formed to protrude toward the upstream side of the air flow direction. In addition, the conductive electrode patterns 170 and 180 may be formed simultaneously on the upper and lower surfaces of the second dielectric layer 101.

Referring to FIG. 21, the conductive electrode pattern 170 may be formed on the second dielectric layer 101. The electrostatic electrode pattern 170 may be a pattern in which pointed shapes are continuously arranged toward the semi-conductive filter mesh 40. The conductive electrode pattern 170 may include first protrusions 171 and second protrusions 172 that are adjacent to each other in the continuous pattern.

The first protrusions 171 may each include a first inclined portion 171a, a second inclined portion 171c continuously connected to the first inclined portion 171a, and a first ridge portion 171b where the first inclined portion 171a and the second inclined portion 171c meet. Similarly, the second protrusions 172 may each include a first inclined portion 172a, a second ridge portion 172b, and a second inclined portion 172c.

Both the first protrusions 171 and the second protrusions 172 may be discharge portions. Here again, as described above, the largest amount of ions may be emitted from the first ridge portion 171b, which is a portion formed to protrude toward the semi-conductive filter mesh 40 of the first protrusion 171, and the second ridge portion 172b, which is a portion formed to protrude toward the semi-conductive filter mesh 40 of the second protrusion 172. The distance P between the adjacent discharge portions 171 and 172 may be a distance between the first ridge portion 171b and the second ridge portion 172b. In addition, the distance D between the semi-conductive filter mesh 40 and the discharge portion 171 or 172 may be the shortest distance between the semi-conductive filter mesh 40 and the first ridge portion 171b or the second ridge portion 182b.

The distance P between the adjacent discharge portions 171 and 172 may be formed to be greater than the distance D between the semi-conductive filter mesh 40 and the discharge portion 171 or 172.

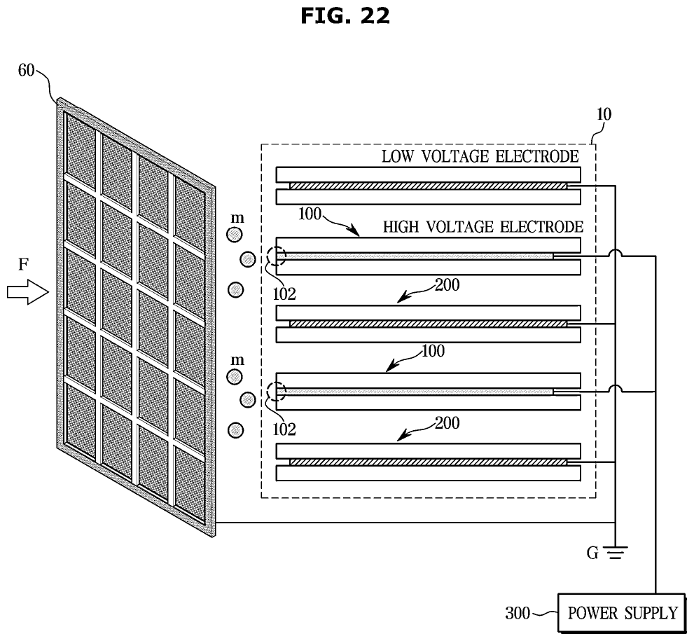

Referring to FIG. 22, when the semi-conductive structures 40 and 50 and the dust collection sheet 10 are disposed at a sufficiently distant position in FIG. 4, sparks may not be generated between the semi-conductive structures 40 and 50 and the dust collection sheet 10, so that the resistance R between the conductive member 60 and the ground G may be omitted.

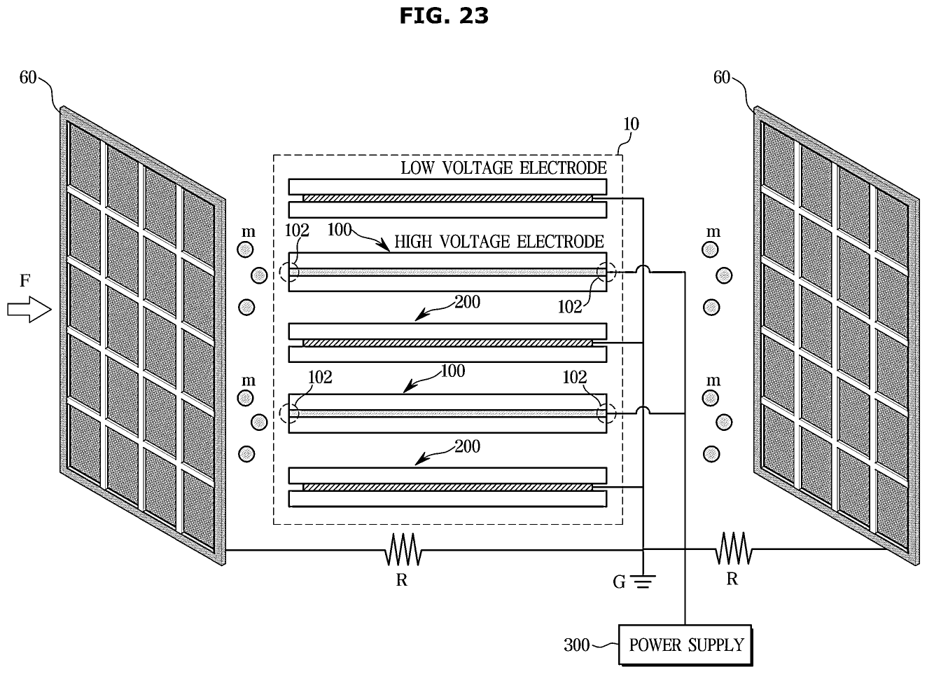

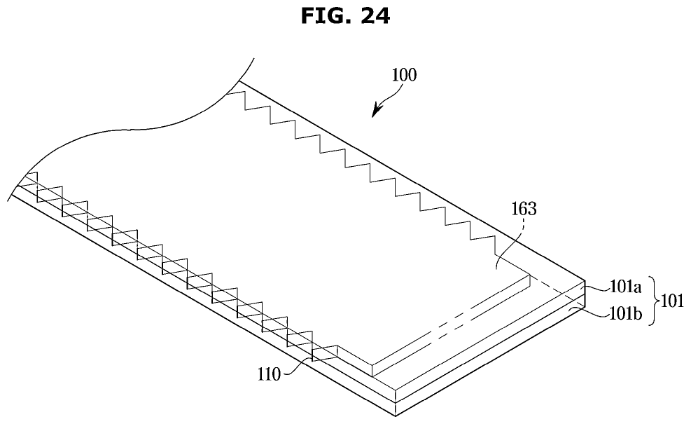

Referring to FIGS. 23 and 24, the semi-conductive structures 40 and 50 may be disposed not only on the upstream side of the air flow direction F but also on the downstream side, ions may be released through the opening 102 on the downstream side of the high-voltage electrode 100.

In such a case, a second conductive electrode layer 163 may be formed such that the upstream and downstream sides of the second conductive electrode layer 163 protrude in a sawtooth shape with respect to the air flow direction F. A portion of the second conductive electrode layer 163 may be exposed to the outside through the openings 110 formed on the upstream and downstream sides of the second dielectric layer 101. As described above, although not limited to such a structure, the distance P between the discharge portions that are exposed to the outside and emit ions may be formed to be greater than the distance D between the semi-conductive structures 40 and 50 and the discharge portion.

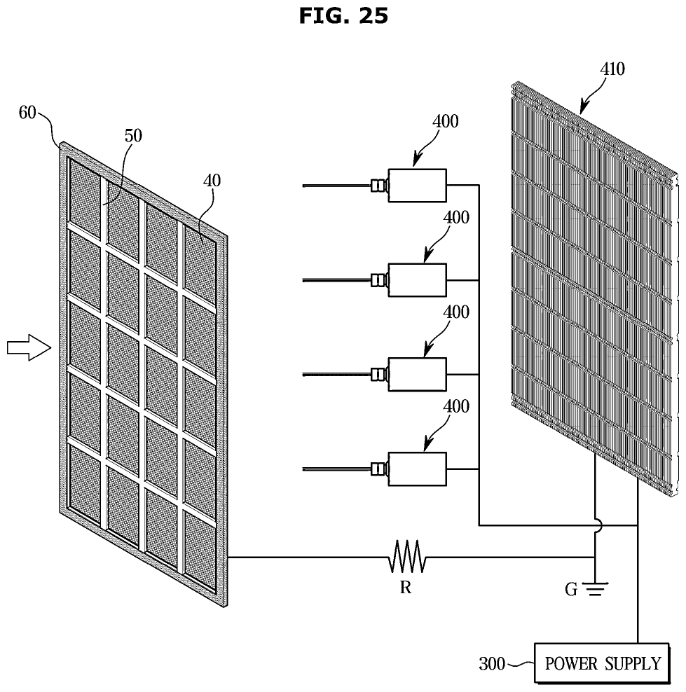

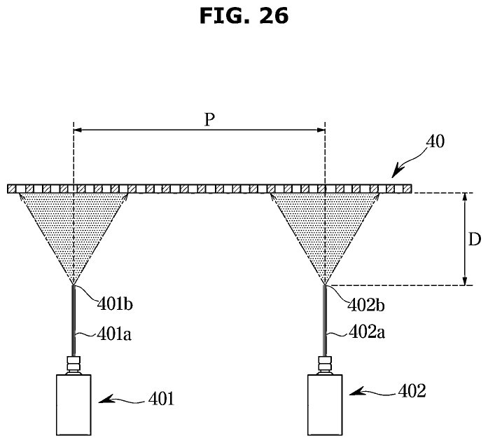

FIGS. 25 and 26 illustrate the semi-conductive filter mesh 40 and the conductive member 60 positioned on an upstream side of a carbon brush 400 according to various embodiments. The semi-conductive filter mesh 40 and the conductive member 60 may more effectively diffuse ions emitted from the carbon brushes 400. Due to the electricity uniformly formed in the semi-conductive filter mesh 40 by the conductive member 60, the ions may be distributed uniformly over the entire area of the semi-conductive filter mesh 40. Accordingly, the amount of charge in the aerosols may be increased.

The aerosols charged by the ions released by the carbon brushes 400 may be collected in a dust collection filter 410 located on the downstream side of the air flow path. The dust collection filter 410 may form an electric field when a voltage is applied, and thus the charged aerosols may be trapped to the dust collection filter 410.

The dust collection filter 410 may include a plurality of high-voltage electrodes and a plurality of low-voltage electrodes, such as the dust collection sheet 10 according to an embodiment. However, due to the presence of carbon brush electrodes 401a and 402a that generate ions, the high-voltage electrodes and/or low-voltage electrodes of the dust collection filter 410 may not be provided with openings.

The carbon brushes 400 may include a first carbon brush 401 and a second carbon brush 402 that are adjacent to each other. The first carbon brush 401 may include the first carbon brush electrode 401a, and the second carbon brush 402 may include the second carbon brush electrode 402a. The first carbon brush electrode 401a and the second carbon brush electrode 402a may each be disposed facing the semi-conductive filter mesh 40, and may have a shape extending in the front-to-back direction of the air flow direction.

A distance between the semi-conductive filter mesh 40 and the first carbon brush 401 or the second carbon brush 402 may be closest at a first end 401b of the first carbon brush electrode 401a and a first end 402b of the second carbon brush electrode 402a, respectively. The first carbon brush electrode 401a may be the first discharge portion 401a, and the second carbon brush electrode 402a may be the second discharge portion 402a.

Here again, as described above, the distance P between the adjacent discharge portions 401b and 402b may be set to be greater than the distance D between the semi-conductive filter mesh 40 and the discharge portion 401b or 402b. According to such a structure, ions emitted from the adjacent carbon brushes 400 may be prevented/reduced from electrically interfering with each other, thereby increasing the dust collection efficiency in the semi-conductive structures 40 and 50.

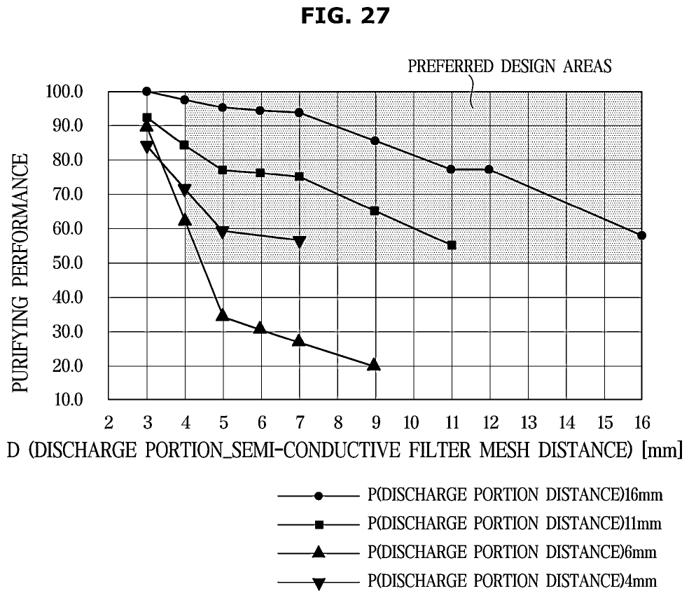

FIG. 27 is a graph illustrating example purifying performance (or a cleaning performance) as a function of the distance P between the discharge portions and the distance D between the discharge portion and the semi-conductive filter mesh 40 (see FIG. 4). For standards, 90 to 100% of the purifying performance may be targeted. The distance P between the discharge portions may be the distance P between the adjacent discharge portions, and the distance D between the discharge portion and the semi-conductive filter mesh may be the shortest distance between each adjacent discharge portion and the semi-conductive filter mesh. When the distance P between the discharge portions is 4, 6, 11 and 16 mm, it can be seen that the smaller the distance D between the discharge portion and the semi-conductive filter mesh 40, the higher the purifying performance. However, if the distance D between the discharge portion and the semi-conductive filter mesh 40 is too close, sparks or discharge noise may occur. To prevent and/or reduce such phenomenon and to provide the purifying performance of 50% or more, it may be desirable for the distance D between the discharge portion and the semi-conductive structures 40 and 50 to be 4 mm or more. Correspondingly, the distance P between the discharge portions should be greater than the distance D between the discharge portion and the semi-conductive structures 40 and 50, so that it may be desirable for the distance P between the discharge portions to be 4 mm or more.

While the disclosure has been illustrated and described with reference to various example embodiments, it will be understood that the various example embodiments are intended to be illustrative, not limiting. It will also be understood by those \skilled in the art that various changes in form and detail may be made without departing from the true spirit and full scope of the present disclosure, including the appended claims and their equivalents. It will also be understood that any of the embodiment(s) described herein may be used in conjunction with any other embodiment(s) described herein.

What is claimed is:

1. An electric dust collecting device comprising:
a semi-conductive structure including at least one of a semi-conductive filter mesh or a semi-conductive grille;
a plurality of low-voltage electrodes disposed on a downstream side of an air flow path of the semi-conductive structure, including a first dielectric layer and a first conductive electrode layer in the first dielectric layer, and configured to receive an applied low voltage below a threshold voltage; and
a plurality of high-voltage electrodes arranged alternately with the plurality of low-voltage electrodes, including a second dielectric layer and a second conductive electrode layer in the second dielectric layer, and configured to receive an applied high-voltage greater than a threshold voltage;
wherein the second conductive electrode layer includes a first discharge portion exposed to the outside of the second dielectric layer in an air flow direction and a second discharge portion adjacent to the first discharge portion, and
a distance P between the first discharge portion and the second discharge portion is greater than a distance D between the first discharge portion or second discharge portion and the semi-conductive structure.

2. The electric dust collecting device of claim 1, wherein the first discharge portion and the second discharge portion protrude toward the semi-conductive structure.

3. The electric dust collecting device of claim 2, wherein
the first discharge portion includes a first protrusion protruding toward the semi-conductive structure, and the second discharge portion includes a second protrusion adjacent to the first protrusion, and
the distance D is a shortest distance from the first protrusion or the second protrusion to the semi-conductive structure.

4. The electric dust collecting device of claim 3, wherein
each of the first protrusion and the second protrusion includes a sawtooth shape protruding toward an upstream side of an air flow,
each the first protrusion and the second protrusion includes a first inclined portion facing the semi-conductive structure from a base, and a second inclined portion forming a ridge portion meeting the first inclined portion, and
the distance P is a distance between the ridge portion of the first protrusion and the ridge portion of the second protrusion, and the distance D is a distance between the ridge portion of the first protrusion or the ridge portion of the second protrusion and the semi-conductive structure.

5. The electric dust collecting device of claim 4, wherein the first protrusion and the second protrusion are arranged continuously.

6. The electric dust collecting device of claim 4, wherein the first protrusion and the second protrusion are spaced apart from each other.

7. The electric dust collecting device of claim 1, wherein the first discharge portion and the second discharge portion extend in a direction intersecting the air flow direction on an upstream side of the second dielectric layer and are arranged to be spaced apart from each other.

8. The electric dust collecting device of claim 7, wherein
the first discharge portion and the second discharge portion are exposed to the outside through a plurality of openings on the upstream side of the second dielectric layer, and
the distance D is a shortest distance between two adjacent openings of the plurality of openings.

9. The electric dust collecting device of claim 1, wherein the second dielectric layer includes a plurality of openings having a V-shape formed on at least one of upper and lower surfaces of the second dielectric layer, and an angled portion of each of the V-shaped openings faces an upstream side based on the air flow direction.

10. The electric dust collecting device of claim 9, wherein
the distance P is a distance between the angled portions of two adjacent V-shaped openings of the plurality of openings, and
the distance D is a distance between the angled portion of each of the two adjacent V-shaped openings of the plurality of openings and the semi-conductive structure.

11. The electric dust collecting device of claim 1, wherein the second dielectric layer includes a plurality of openings having a W-shape formed on at least one of upper and lower surfaces of the second dielectric layer, and an angled portion of each of the W-shaped openings faces an upstream side based on the air flow direction.

12. The electric dust collecting device of claim 11, wherein
the distance P is a distance between the angled portions of two adjacent W-shaped openings of the plurality of openings, and
the distance D is a distance between the angled portion of the two adjacent W-shaped openings of the plurality of openings and the semi-conductive structure.

13. The electric dust collecting device of claim 1, wherein
each of the plurality of high-voltage electrodes further includes a dust collection portion located on a downstream side of the first discharge portion and the second discharge portion with respect to the air flow direction, and
the first discharge portion and the second discharge portion are formed integrally with the dust collection portion.

14. The electric dust collecting device of claim 1, wherein the semi-conductive structure has a surface resistance in a range of 10⁶ [ohm/sq] to 10¹¹ [ohm/sq] or less.

15. The electric dust collecting device of claim 1, wherein
the distance D between the semi-conductive structure and the first discharge portion or the second discharge portion is 4 mm or more, and the distance P between the first discharge portion and the second discharge portion is 4 mm or more.

16. An electric dust collecting device comprising:
a plurality of low-voltage electrodes including a first dielectric layer including an upper dielectric layer and a lower dielectric layer, and a first conductive electrode layer inside the first dielectric layer,
a plurality of high-voltage electrodes arranged alternately with the plurality of low-voltage electrodes and including a second dielectric layer including an upper dielectric layer and a lower dielectric layer and a second conductive electrode layer inside the second dielectric layer, and
a semi-conductive structure disposed on an upstream side of an air flow direction and including at least one of a semi-conductive filter mesh or a semiconducting grille,
wherein the second conductive electrode layer includes a discharge portion that protrudes to face the semi-conductive structure and has one end exposed to the outside, and the discharge portion is provided in a plurality, wherein a distance P between a first discharge portion and a second discharge portion disposed adjacent to each other is greater than a distance D between the first discharge portion or the second discharge portion and the semi-conductive structure.

17. The electric dust collecting device of claim 16, wherein
the first discharge portion include a first protrusion protruding toward the semi-conductive structure and the second discharge portion includes a second protrusion adjacent to the first protrusion, and
the distance D is a shortest distance from the first protrusion or the second protrusion to the semi-conductive structure.

18. The electric dust collecting device of claim 17, wherein
each of the first protrusion and the second protrusion includes a sawtooth shape that protruding toward an upstream side of an air flow,
each the first protrusion and the second protrusion includes a first inclined portion facing the semi-conductive structure from a base and a second inclined portion forming a ridge portion meeting the first inclined portion, and
the distance P is a distance between the ridge portion of the first protrusion and the ridge portion of the second protrusion, and the distance D is a distance between the ridge portion of the first protrusion or the ridge portion of the second protrusion and the semi-conductive structure.

19. The electric dust collecting device of claim 16, wherein the first discharge portion and the second discharge portion extend in a direction intersecting the air flow direction on an upstream side of the second dielectric layer and be arranged to be spaced apart from each other.

20. An electric dust collecting device comprising:
a semi-conductive structure including at least one of a semi-conductive filter mesh or a semi-conductive grille, and
a plurality of carbon brushes disposed on a downstream side of the semi-conductive structure in an air flow path, and including a discharge portion disposed toward the semi-conductive structure to emit ions toward the semi-conductive structure,
wherein a distance P between two adjacent discharge portions of the plurality of carbon brushes is greater than a distance D between the two discharge portions and the semi-conductive structure.
